(19) United States
(12) Patent Application Publication
(10) Pub. No.: US 2009/0231493 A1
(43) Pub. Date: Sep. 17, 2009

(54) SYSTEMS AND METHODS FOR CONTROLLING CONTENT PLAYBACK

(76) Inventors: Aaron Baalbergen, Miami, FL (US); Demian Martin, San Leandro, CA (US)

Correspondence Address: IPSG, P.C., P.O. BOX 700640, SAN JOSE, CA, 95170, US

(21) Appl. No.: 12/046,395

(22) Filed: Mar. 11, 2008

(51) Int. Cl. H04N 5/445; H04N 5/44; G06F 3/041

(52) U.S. Cl. 348/734; 345/173

(57) ABSTRACT

A method for controlling playback of content is disclosed. The content may be played using a playback unit. The method may include monitoring the content. The method may also include determining whether a portion of the content being displayed on a display device contains any actionable zones that are configured for facilitating user input. The method may also include showing a copy of the portion of the content on a touch-screen device if the portion of the content contains at least one or more actionable zones. The copy of the portion of the content may contain at least a copy of the one or more actionable zones.

### BACKGROUND OF THE INVENTION

The present invention relates to controlling the playback of media/content, such as video, audio, image, and/or text content. In particular, the invention may relate to content playback control involving on-screen actionable zones (or actionable items) or menus that are displayed on a display device for facilitating user input.

For example, when a movie is initiated by a media player, such as DVD (Digital Versatile Disk) player, a menu including several actionable zones may be displayed on a television to enable the user (or the viewer of the movie) to choose from several options, such as viewing the movie (by selecting the first actionable zone), accessing a scene selection menu (by selecting the second actionable zone), accessing language options (by selecting the third actionable zone), accessing caption options (by selecting the fourth actionable zone), etc.

Conventionally, the user of the content may utilize a remote control device associated with the media player to navigate the menu for selecting the desirable actionable zone. The process may involve locating the desirable actionable zone on the television screen, pressing one or more arrow buttons (or direction buttons) one or more times to reach the desirable actionable zone such that the desirable actionable zone is indicated or highlighted, and pressing a confirmation button to confirm the selection of the indicated actionable zone. Since the user is typically seated away from the television screen, the actionable zones may not be clearly legible to the user. As a result, the user may need to move closer to the television screen for locating the desirable actionable zone to make the selection and may need to move back to the seat after the selection has been made. Accordingly, substantial inconvenience may be caused. Further, frequent pressing or holding the arrow buttons may result in mechanical failure of the buttons, rendering the remote control device unusable.

### SUMMARY OF INVENTION

An embodiment of the present invention relates to a method for controlling playback of content. The content may be played using a playback unit. The method may include monitoring the content. The method may also include determining whether a portion of the content being displayed on a display device contains any actionable zones that are configured for facilitating user input. The method may also include showing a copy of the portion of the content on a touch-screen device if the portion of the content contains at least one or more actionable zones. The copy of the portion of the content may contain at least a copy of the one or more actionable zones.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a schematic representation illustrating a system for controlling content playback in accordance with one or more embodiments of the present invention.

FIG. 2 shows a flowchart illustrating a method for controlling content playback in accordance with one or more embodiments of the present invention.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

One or more embodiments of the present invention relate to a method for controlling content playback involving on-screen actionable zones. According to the method, a copy of actionable zones (or a menu) may be presented on a touch-screen device that is close to the user, as a result, the legibility of the actionable zones may be substantially improved. Further, according to the method, the user may intuitively and easily select the desirable actionable zone by simply touching a copy of the desirable actionable zone shown on the touch-screen device at hand. Advantageously, substantial convenience and ease of use may be provided for the user to view the actionable zones and to select the desirable actionable zone.

The method may include showing on a touch-screen device a copy of a content portion being displayed (on a display device, e.g., a television screen) if and/or only if the content portion contains actionable zones. Accordingly, a copy of the actionable zones may be displayed on the touch-screen device, and the user may intuitively and directly touch the copy of the desirable actionable zone to select the desirable actionable zone. The touch-screen device may generate a set of coordinates (e.g., one or more Cartesian coordinates) based on the user's touch. The touch-screen device and/or the playback unit (e.g., a media player) that plays the content may then translate the set of coordinates to the appropriate command associated with the desirable actionable zone.

In one or more embodiments, the method may also include showing an additional control panel on the touch-screen device to provide an alternative way for navigating the actionable zones. The control panel may include one or more direction-movement zones, such that the user may control the movement of the indicator (e.g., a pointer and/or a highlighting effect) shown on the touch-screen device (and the indicator shown on the display device) to select the desirable actionable zone by touching the direction-movement zones.

One or more embodiments of the invention may relate to a system for implementing the method for controlling content playback.

The features and advantages of the invention may be better understood with reference to the figures and discussions that follow.

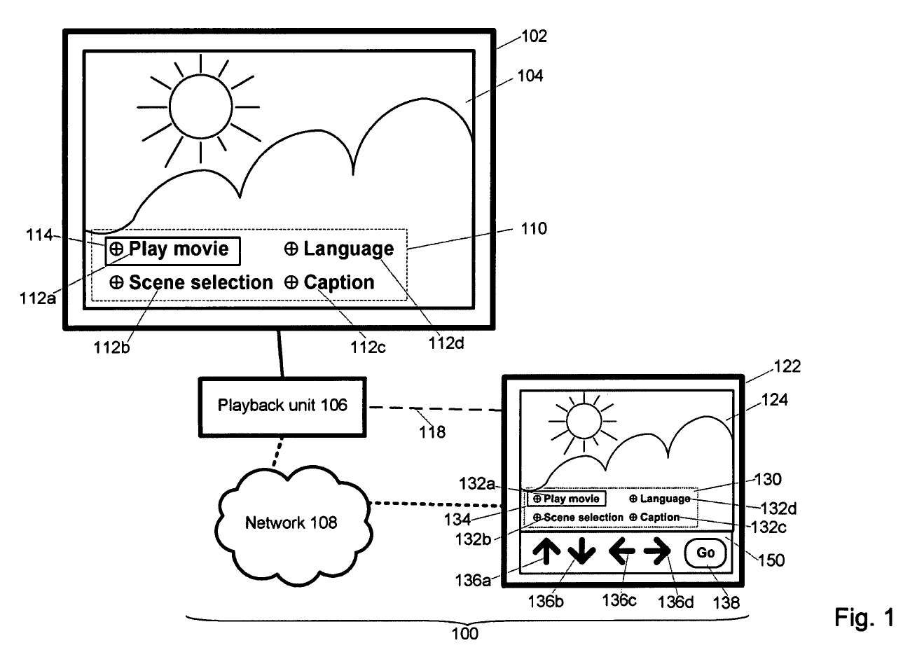

FIG. 1 shows a schematic representation illustrating a system 100 for controlling content playback in accordance with one or more embodiments of the present invention. As an example, the content (or at least an image or video portion of the content) may be presented utilizing a display device 102. The content may be implemented in a well-known digital format, such as a VOB (Video Object) format or an MPEG (Moving Picture Experts Group) format, with several actionable zones embedded. For example, a portion 104 of the content being displayed on display device 102 may contain a menu 110 that includes actionable zones (or menu items) 112a, 112b, 112c, and 112d. The user of the content may move an indicator 114 (e.g., a highlighting effect, pointer, and/or format change) to navigate menu 110 for selecting a desirable actionable zone (or menu item).

System 100 may include a playback unit 106. Playback unit 106 may include a software component and/or a hardware device for playing the content. For example, playback unit may represent one or more of a software media player, a DVD player, a Blu-ray Disc™ player, a hard disc drive equipped media player, etc. Playback unit 106 may include a control/logic unit for monitoring and controlling the playback of the content.

System 100 may also include a touch-screen device 122, such as a personal digital assistance (PDA), a smart phone, a Web pad, or a tablet computer. Touch-screen 122 may display a content portion 124 that may be a scaled copy of portion 104 and/or may be similar to portion 104. Content portion 124 may contain a menu 130 that may be a scaled copy of menu 110 and/or may be similar to menu 110. Menu 130 may include actionable zones 132a, 132b, 132c, and 132d that may be scaled copies of actionable zones 112a, 112b, 112c, and 112d, respectively, and/or may be similar to actionable zones 112a, 112b, 112c, and 112d, respectively. The user may simply touch one of actionable zones 132a, 132b, 132c, and 132d displayed on touch-screen device 122 at hand to select the desirable actionable zone, without needing to locate the desirable actionable zone among actionable zones 112a, 112b, 112c, and 112d, which are displayed on the typically farther display device 102 and may be less legible.

Touch-screen device 122 may also display a control panel 150 in addition to content portion 124 to provide an alternative mechanism for the user to select the desirable actionable zone. Control panel 150 may include several direction zones, such as direction zones 136a, 136b, 136c, and 136d, for example, to move an indicator 134 upwards, downwards, to the left, and to the right, respectively. Indicator 134 may be a copy of or similar to indicator 114 shown on display device 102. The user may simply touch one or more of the direction zones for moving indicator 134 to navigate menu 130 at hand without needing to navigate the typically farther and less legible menu 110. Control panel 150 may also include a confirmation zone 138 (e.g., presented as a “Go” or “Enter” button) for the user to confirm the selection of the indicated (and/or highlighted) actionable zone.

Touch-screen device 122 and playback unit 106 may be coupled through a connection 118, which may be a wireline connection or a wireless connection implemented based on a well-known protocol. Alternatively or additionally, touch-screen device 122 and playback unit 106 may be coupled through a network 108, such as home network (which may include a router) and/or the Internet.

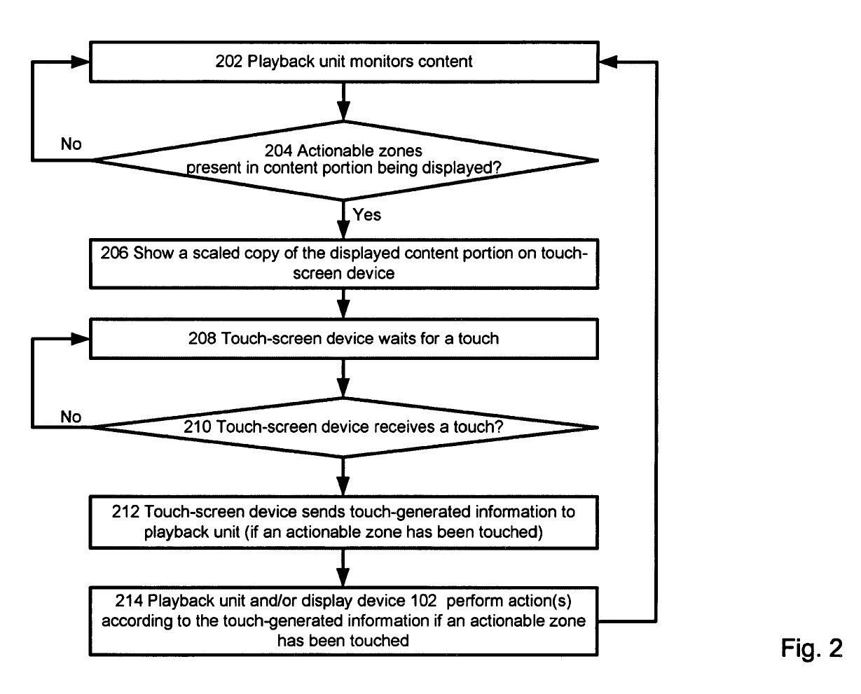

Example functions, features, and advantages of system 100 are further discussed with reference to the examples of FIG. 2.

FIG. 2 shows a flowchart illustrating a method for controlling content playback in accordance with one or more embodiments of the present invention. The method may be implemented, for example, utilizing system 100 illustrated in the example of FIG. 1. The method may also be discussed with reference to the example of FIG. 1. The method may start with step 202, in which playback unit 106 may monitor the content.

In step 204, playback unit 106 may determine whether any actionable zones are present in the portion of the content currently being displayed. If the portion of the content does not contain any actionable zones, control may be transferred back to step 202. If the portion of the content contains one or more actionable zones, as illustrated by portion 104 shown in the example of FIG. 1, control may be transferred to step 206.

In step 206, touch-screen device 122 may show a scaled copy of the portion of the content, as illustrated by content portion 124 containing actionable zones 132a-132d shown in the example of FIG. 1. Content portion 124 may be transmitted from playback unit 106 to touch-screen device 122 in an image file, such as a JPEG (Joint Photographic Experts Group) file. Alternatively or additionally, content portion 124 may be transmitted from playback unit 106 to touch-screen device 122 in a data stream or in a video file. Content portion 124 may be scaled according to one or more well-known methods to fit the touch screen or a viewable area of touch-screen device 122.

In step 208, touch-screen device 122 may wait for a touch by the user.

In step 210, touch-screen device 122 may determine whether a touch is received. If no touch is received, control may be transferred back to step 208. If a touch is received, control may be transferred to step 212.

In step 212, touch-screen device 122 may generate information based on the touch and may transmit the information to playback unit 106. The information may represent a set of coordinates (e.g., one or more Cartesian coordinates) generated by touch-screen device 122 according to the position of the touch. Touch-screen device 122 may transmit the set of coordinates to playback unit 106.

In one or more embodiments, touch-screen device 122 may determine whether the set of coordinates represents a copy of an actionable zone. Touch-screen device 122 may not transmit the set of coordinates to playback unit 106 if the set of coordinates does not represent an actionable zone. As a result, network resource may be conserved.

In one or more embodiments, if an actionable zone has been touched, i.e., if the set of coordinates represents an actionable zone, touch-screen device 122 may translate the set of coordinates to a command associated with the actionable zone. Accordingly, the generated information may represent the command, and touch-screen device 122 may transmit the command to playback unit 106.

In step 214, playback unit 106 and/or display device 102 may perform a set of actions (i.e., one or more actions) according to the touch-generated information received from touch-screen device 122 if an actionable zone has been touched on touch-screen device 122. If the received information includes a set of coordinates that represents a touched actionable zone, playback unit 106 may translate the set of coordinates to a command associated with the touched actionable zone, and playback unit 106 and/or display device 102 may then perform the set of actions according to the command. If the information includes a command, playback unit 106 and/or display device 102 may directly perform the set of actions according to the command.

The method may also include showing control panel 150 on touch-screen device 122. Touch-screen device 122 may show control panel 150 if and/or only if playback unit 106 has determined that the portion of the content currently being displayed contains one or more actionable zones. Control panel 150 may be removed, hidden, or minimized when the actionable zones are not displayed.

When control panel 150 is shown, touch-screen device 122 may receive a touch by the user on a direction zone, such as one of direction zones 136a-136d. According to the touched direction zone, touch-screen device 122 may generate a set of coordinates (e.g., one or more Cartesian coordinates). Subsequently, touch-screen device 122 and/or playback unit 106 may translate the set of coordinates to a direction. Accordingly, touch-screen device 122 may move an indicator (e.g., indicator 134 illustrated in the example of FIG. 1) in the direction to an actionable zone (e.g., actionable zone 132a illustrated in the example of FIG. 1) displayed on touch-screen device 122. Playback unit 106 and/or display device 102 may also move a corresponding indicator (e.g., indicator 104 illustrated in the example of FIG. 1) in the direction to a corresponding actionable zone (e.g., actionable zone 112a illustrated in the example of FIG. 1) displayed on display device 102. The indicators may move multiple times in an appropriate direction if the associated direction zone is touched multiple times or continuously touched.

Touch-screen device 122 may further receive a touch by the user on confirmation zone 138. In response, touch-screen device 122 may generate a set of coordinates associated with the touched portion of confirmation zone 138. Subsequently, touch-screen device 122 and/or playback unit 106 may translate the set of coordinates to a confirmation command for confirming that the indicated actionable zone is selected.

In one or more embodiments, if actionable zones are present, touch-screen device 122 may show control panel 150 without displaying content portion 124 and the actionable zones, for example, to conserve energy when the battery of touch-screen device 122 is low. Accordingly, touch-screen device 122 may serve as an on-demand remote control device for playback unit 106 with minimized energy consumption.

In various embodiments, the tasks of translating between coordinates and commands may be distributed between touch-screen device 122 and playback unit 106 utilizing various arrangements.

As can be appreciated from the foregoing, embodiments of the invention may present actionable zones close to a user when the user consumes content. Accordingly, the legibility of the actionable zones may be substantially improved. Advantageously, the user may conveniently select the desirable actionable zone with minimum effort (e.g., body movement).

Embodiments of the invention may also enable the user to intuitively and easily select the desirable actionable zone by simply touching a copy of the desirable actionable zone at hand. Advantageously, the desirable actionable zone may be efficiently selected with minimum operation.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A method for controlling playback of content, the content played using a playback unit, the method comprising:
monitoring the content;
determining whether a portion of the content being displayed on a display device contains any actionable zones that are configured for facilitating user input; and
showing a copy of the portion of the content on a touch-screen device if the portion of the content contains at least one or more actionable zones, wherein the copy of the portion of the content contains at least a copy of the one or more actionable zones.

2. The method of claim 1 further comprising:
receiving a touch on the touch-screen device;
generating a set of coordinates based on the touch; and
translating the set of coordinates to a command associated with an actionable zone of the one or more actionable zone.

3. The method of claim 2 further comprising transmitting the set of coordinates from the touch-screen device to the playback unit, wherein the translating is performed by the playback unit.

4. The method of claim 2 further comprising transmitting the command from the touch-screen device to the playback unit, wherein the translating is performed by the touch-screen device.

5. The method of claim 1 further comprising transmitting the copy of the portion of the content in a data stream from the playback unit to the touch-screen device if the portion of the content contains the one or more actionable zones.

6. The method of claim 1 further comprising transmitting the copy of the portion of the content in an image file from the playback unit to the touch-screen device if the portion of the content contains the one or more actionable zones.

7. The method of claim 1 further comprising showing a control panel on the touch-screen device if the portion of the content contains the one or more actionable zones, the control panel including at least one or more direction zones for controlling movement of an indicator shown on the display device.

8. The method of claim 7 further comprising:
receiving a touch from a direction zone of the one or more direction zones on the control panel;
generating a set of coordinates based on the touch;
translating the set of coordinates to a direction; and
moving the indicator in the direction to an actionable zone of the one or more actionable zone shown on the display device.

9. The method of claim 8 further comprising moving a copy of the indicator in the direction to a copy of the actionable zone shown on the touch-screen device.

10. The method of claim 8 further comprising:
receiving a second touch on the control panel; and
generating a second set of coordinates based on the second touch; and
translating the second set of coordinates to a confirmation command for confirming that the actionable zone of the one or more actionable zone is selected.

11. The method of claim 10 further comprising transmitting the second set of coordinates from the touch-screen device to the playback unit, wherein the translating is performed by the playback unit.

12. The method of claim 10 further comprising transmitting the confirmation command from the touch-screen device to the playback unit, wherein the translating is performed by the touch-screen device.

13. A method for controlling playback of content, the content played by a playback unit, the method comprising:
monitoring the content;
determining whether a portion of the content being displayed on a display device contains any actionable zones that are configured for facilitating user input; and
showing a control panel on a touch-screen device if the portion of the content contains one or more actionable zones, the control panel including at least one or more direction zones for controlling movement of an indicator shown on the display device.

14. The method of claim 13 further comprising:
receiving a touch from a direction zone on the control panel;
generating a set of coordinates based on the touch;
translating the set of coordinates to a direction; and
moving the indicator in the direction to an actionable zone of the one or more actionable zone shown on the display device.

15. The method of claim 14 further comprising:
receiving a second touch on the control panel; and
generating a second set of coordinates based on the second touch; and
translating the second set of coordinates to a confirmation command for confirming that the actionable zone of the one or more actionable zone is selected.

16. A system for controlling playback of content, the system comprising:
at least one of a playback unit and a touch-screen device, the playback unit configured to monitor the content, the playback unit further configured to determine whether a portion of the content being displayed on a display device contains any actionable zones that are configured for facilitating user input, the playback unit further configured to transmit a copy of the portion of the content to the touch-screen device if the portion of the content contains one or more actionable zones, the copy of the portion of the content containing a copy of the one or more actionable zones.

17. The system of claim 16 wherein the touch-screen device is configured to display the copy of the portion of the content, the touch-screen device further configured to receive a touch, the touch-screen device further configured to generate a set of coordinates based on the touch, the touch-screen device further configured to translate the set of coordinates to a command associated with an actionable zone of the one or more actionable zone, the touch-screen device further configured to transmit the command to the playback unit.

18. The system of claim 16 wherein the touch-screen device is configured to display the copy of the portion of the content, the touch-screen device further configured to receive a touch, the touch-screen device further configured to generate a set of coordinates based on the touch, the touch-screen device further configured to transmit the set of coordinates to the playback unit, the playback unit further configured to translate the set of coordinates to a command associated with an actionable zone of the one or more actionable zone.

19. The system of claim 16 wherein the touch-screen device is configured to show a control panel if the portion of the content contains the one or more actionable zones, the control panel including at least one or more direction zones for controlling movement of an indicator on the display device.

20. The system of claim 19 wherein the touch-screen device is further configured to receive a touch from a direction zone of the one or more direction zones on the control panel, the touch-screen device further configured to generate a set of coordinates based on the touch, the touch-screen device further configured to translate the set of coordinates to a direction, the touch-screen device further configured to transmit a signal associated with the direction to the playback unit, the playback unit further configured to determine an actionable zone of the one or more actionable zone based on at least the direction.
